(19) United States
(12) Patent Application Publication
(10) Pub. No.: US 2010/0039704 A1
(43) Pub. Date: Feb. 18, 2010

(54) PRISM SHEET AND OPTICAL SHEET

(76) Inventors: Hideki Hayashi, Osaka (JP); Takehiko Iwasa, Kanagawa (JP); Shinzo Makino, Aichi (JP)

Correspondence Address: Cheng Law Group, PLLC, 1100 17th Street, N.W., Suite 503, Washington, DC, 20036, US

(21) Appl. No.: 12/447,117

(22) PCT Filed: Oct. 27, 2006
(86) PCT No.: PCT/JP2006/321500

§ 371 Date: Apr. 24, 2009

(51) Int. Cl. G02B 5/30

(52) U.S. Cl. 359/485

(57) ABSTRACT

A prism sheet is provided for making it possible to ensure high brightness and a wide viewing angle characteristic in a state integrated with a reflective polarizing function film. A prism sheet (7) is composed of a plurality of lens units (7a) which each have substantially triangle shapes in cross-section and extend along their ridgelines and are formed in parallel at least on a surface. The prism has such a structure that it is put between a pair of polarizers disposed in a cross Nicol arrangement to make its ridge line consistent with a transmission axis of either of the polarizers. The total transmittance of light beams incident from the external surface on the shape arrangement side of such structured prism sheet (7) is not larger than 2% of the total transmittance of light beams through such a parallel Nicol structure of a pair of polarizers that no prim sheet is put between them.

### TECHNICAL FIELD

The present invention relates to a prism sheet and an optical sheet used for a backlight of a liquid crystal display, for example. More particularly, the present invention relates to a prism sheet having a structure in which a plurality of lens units having substantially triangle shapes in cross section are formed in parallel, and an optical sheet with the use of the prism sheet.

### BACKGROUND ART

In recent years, color liquid crystal displays have been widely used in various fields, such as monitors of laptop computers, desktop computers or the like, and liquid crystal televisions. These kinds of liquid crystal displays are provided with liquid crystal cells and backlights. As a backlight, there are known the structure of direct type where a light source is provided directly under a liquid crystal cell, or the structure of edge light type where a light source is provided on the side face of a light guide plate.

The liquid crystal display having the general structure is provided with a bar lamp as a light source, a plurality of optical sheets, and liquid crystal cells. In the case of the edge light type, the liquid crystal display is further provided with a rectangular plate-shaped light guide plate disposed so as to extend along the end portion of the lamp, and the optical sheets are laminated on the surface of the light guide plate. Each of the optical sheets has specific optical functions such as refraction, diffusion and the like, and specific examples thereof include a light diffusing sheet, a prism sheet and the like.

Although a color liquid crystal display has less power consumption compared with a PDP, a CRT, or an organic light emitting diode display, the front luminance thereof tends to be lower.

There is a need for increase in optical efficiency with the use of a backlight and enhancement of front luminance with little power consumption.

Generally, as lens units of a prism sheet, the lens units having a cross-sectional shape of an isosceles triangle, and having an apex angle, i.e., an angle formed by oblique sides, of 90° have been regarded as most suitable for improving the luminance. Here, it has been considered that the curvature radius of the apex of lens units is desirably 0, that is, the apex desirably has an acute shape.

The prism sheet having lens units of the shape is excellent in: the function of condensing incident light from a backlight on the front by refraction and emitting the light from a lens surface; and the retroreflection function. The retroreflection function is to recycle light, which has not contributed to improvement in front luminance, as the retroreflected light. The retroreflected light is part of the outgoing beam from the backlight, the part being returned to the backlight by refraction. However, there remains a problem that the viewing angle range where a half-luminance angle width, i.e., 50% of a front luminance is obtainable is narrow, resulting in reduction of the viewing angle characteristic.

In the case where the curvature radius of the apex of lens units is 0, that is, the apex has an acute shape, since the outgoing beam from the backlight does not diffuse in directions other than the front direction in the apex, the viewing angle characteristic tended to fall.

Furthermore, when the light emitted from the prism sheet enters a liquid crystal cell in the conventional optical system, since a transmitted light amount is reduced to half by the absorption in the polarizer, and since only the half amount of the light that passed the liquid crystal cell contributes to the vision of an observer, about three quarters of the total light actually results in an optical loss.

Patent Document 1 discloses the structure in which the front luminance is raised by integrating a prism sheet having a condensing function with a reflective polarizing functional film in order to improve the optical loss and further increase efficiency of light. Patent Document 1 also discloses that since the light component of the about three quarters resulting described above is returned to the backlight side with a brightness enhancing reflective polarizer (reflective polarizing functional film) and recycled with the polarization state randomized, the recycling increases light volume by about 70%.

Patent Document 1: JP-B 3448626

### DISCLOSURE OF THE INVENTION

In the structure of the optical system disclosed in Patent Document 1, with respect to the positional relationship of the prism sheet to the reflective polarizing functional film, the prism sheet may be on the upper side (the liquid crystal cell side illustrated in FIG. 10 in Patent Document 1) or on the lower side (the backlight side illustrated in FIG. 13 in Patent Document 1). However, when the prism sheet is on the lower side, it is difficult to integrate the prism sheet with the reflective polarizing functional film, and there is no alternative but to adopt the process of laminating other parts; whereas when the prism sheet is on the upper side, the non-prism surface of the prism sheet is beforehand integrally adhered to the reflective polarizing functional film, advantageously resulting in simplification of the assembling process. However, when the prism sheet is on the upper side, it has become apparent that it suffers from the following problems. Namely, since the conventional prism sheet has the structure obtained by casting the ionizing radiation curing acryl on a prism mold and laminating polyethylene terephthalate as a substrate to be integrated with the substrate and then currying the acryl, it has become apparent that the cooperation of the influence of the polyethylene terephthalate substrate that does not cause a problem in the lower side structure and too large a condensing function of the prism sheet causes the reduction in the front luminance and the decrease in the half-luminance angle width that exhibits an angle of view with which 50% of front luminance is obtainable. The latter problem has become to be prominent in the case where a viewing range separates from a screen front direction especially by enlargement of the recent liquid crystal display.

In view of the prior state of the art, it is an object of the present invention to provide: a prism sheet for making it possible to ensure a high luminance and a wide viewing angle characteristic even in an integrated state with the upper side of a reflective polarizing function film; and an optical sheet with the use of the prism sheet.

A prism sheet according to the present invention comprises a plurality of lens units having substantially triangle shapes in cross section, and having ridge lines extending in a direction perpendicular to the cross section, the plurality of lens units being formed in parallel on at least one surface, wherein T1 and T2 defined below satisfy the following Equation (1)

T1≦T2×0.02 Equation (1)

wherein T1 is a total transmittance of light incident from a side on which the plurality of lens units of the prism sheet are disposed in such a laminate structure that the prism sheet is sandwiched between a pair of polarizers disposed in a cross Nicol arrangement to make a direction in which a ridge line of the lens units extends consistent with a transmission axis of either of the polarizers, and T2 is a total transmittance of light through a laminate structure, the laminate structure consisting of a pair of polarizers disposed in a parallel Nicol arrangement, and no prism sheet being sandwiched between the pair of polarizers. Preferably, T1≦T2×0.01.

According to one specific aspect of the prism sheet of the present invention, a rate of transcription of the plurality of lens units is 50 to 90%, and preferably 60 to 80%.

According to another specific aspect of the prism sheet of the present invention, the prism sheet comprises an optical transparent resin and is produced by a hot-melt extrusion method.

According to still another specific aspect of the prism sheet of the present invention, an apex angle of the cross section of the lens units is 70° to 110°.

According to still another specific aspect of the prism sheet of the present invention, a pitch, which is a distance between apex of adjacent lens units, is 20 to 100 μm.

According to still another specific aspect of the prism sheet of the present invention, a surface roughness of an inclined surface of each of the lens units is 0.1 to 5 μm in terms of a surface roughness “Ra” of Japanese Industrial Standards (JIS) B0601.

According to still another specific aspect of the prism sheet of the present invention, a front luminance reduction rate “C” calculated by {(A−B)/A}×100 is 5% or less, wherein “A” is a front luminance in a case where a standard prism sheet having a thickness of 150 μm, a lens-unit pitch of 50 μm, an apex angle of 90°, and a rate of transcription of 95% or more is disposed below a reflective polarizing functional film so that a prism surface faces the reflective polarizing functional film, and “B” is a front luminance in a case where the prism sheet is disposed above the reflective polarizing functional film so that a non-prism surface faces the reflective polarizing functional film.

According to still another specific aspect of the prism sheet of the present invention, a half-luminance angle width reduction rate “Z” calculated by {(X−Y)/X}×100 is 3% or less, wherein “X” is a half-luminance angle width of a front luminance in a case where a standard prism sheet having a thickness of 150 μm, a lens-unit pitch of 50 μm, an apex angle of 90°, and a rate of transcription of 95% or more is disposed below a reflective polarizing functional film so that a prism surface faces the reflective polarizing functional film, and “Y” is a half-luminance angle width of a front luminance in a case where the prism sheet is disposed above the reflective polarizing functional film so that a non-prism surface faces the reflective polarizing functional film.

An optical sheet comprises: a prism sheet according to the present invention; and a reflective polarizing functional film adhered to a face of the prism sheet opposite to a shaped surface of the prism sheet on which the lens units is formed.

### EFFECTS OF THE INVENTION

In a prism sheet of the present invention that comprises a plurality of lens units having substantially triangle shapes in cross section, and having ridge lines extending in a direction perpendicular to the cross section, the plurality of lens being formed in parallel at least on a surface, the ratio T1/T2 of the total transmittance T1 of light beams to the total transmittance T2 of light beams is 0.02 or less. Accordingly, as is clear from the specific Examples mentioned later, it is possible to ensure a high luminance and a wide viewing angle characteristic even in an integrated state with the upper side of a reflective polarizing function film, and to provide a liquid crystal display having excellent display quality.

In the optical sheet according to the present invention, a reflective polarizing functional film is adhered to a surface of the prism sheet opposite to a shaped surface of the prism sheet on which the lens units is formed. Therefore, upon using the optical sheet for a liquid crystal display, it is possible to secure a high luminance and a large viewing angle characteristic. Meanwhile, it is possible to handle the optical sheet as one component by integrating it, and contribute to the simplification of the assembling process.

### BRIEF DESCRIPTION OF THE DRAWINGS

FIG. 1 is an exploded perspective view schematically illustrating a liquid crystal display apparatus with the use of a prism sheet according to the present invention.

FIGS. 2(a) and 2 (b) are a partially cut-out enlarged perspective view and a partially cut-out cross section, respectively, which illustrate part of a prism sheet according to one embodiment.

FIG. 3 is a configuration view illustrating a production device for producing a prism sheet as a comparative example of the present invention.

FIG. 4 is a configuration view illustrating a production device for producing a prism sheet according to an embodiment illustrated in FIGS. 2(a) and 2(b).

### EXPLANATION OF SYMBOLS

1. Liquid crystal cell
1a, 1b Polarizer
2 Backlight
3 Light source
4 Diffusing plate
5 Diffusing sheet
6 Reflective polarizing functional film
7 Prism sheet
7a Lens unit

### BEST MODE FOR CARRYING OUT THE INVENTION

Hereinafter, specific embodiments of the present invention will be described with reference to drawings.

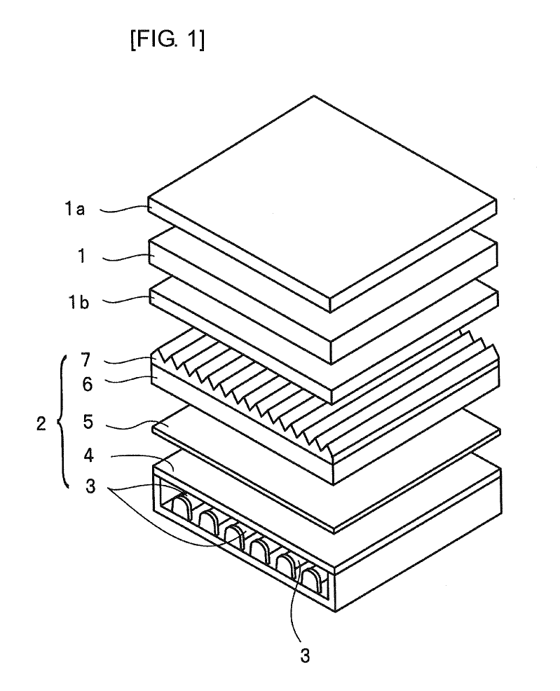

FIG. 1 is an exploded perspective view that schematically illustrates a basic configuration of a liquid crystal display apparatus with the use of a prism sheet according to the present embodiment before describing the prism sheet according to the present embodiment.

The liquid crystal display illustrated in FIG. 1 comprises a liquid crystal cell 1 and a backlight 2 of direct type. Polarizers 1a and 1b are adhered to the upper surface and the lower surface of the liquid crystal cell 1, respectively. The backlight 2 has a light source 3. A diffusing plate 4 for diffusing the light from the light source 3 is fixed to the upper surface of the light source 3. As illustrated, a diffusing sheet 5 that also has a diffusion function, a reflective polarizing functional film 6, and a prism sheet 7 are arranged on the diffusing plate 4.

In the backlight 2, the light from the light source 3 enters the diffusing sheet 5 through the diffusing plate 4. The light that has entered the diffusing sheet 5 is diffused and emitted from the entire surface of the upper surface of the diffusing sheet 5. The light emitted from the diffusing sheet 5 passes through the reflective polarizing functional film 6, enters the prism sheet 7, is emitted with an intensity distribution that exhibits a peak in a direction substantially right above from the upper surface of the prism sheet 7, and illuminates the entire surface of the liquid crystal cell 1.

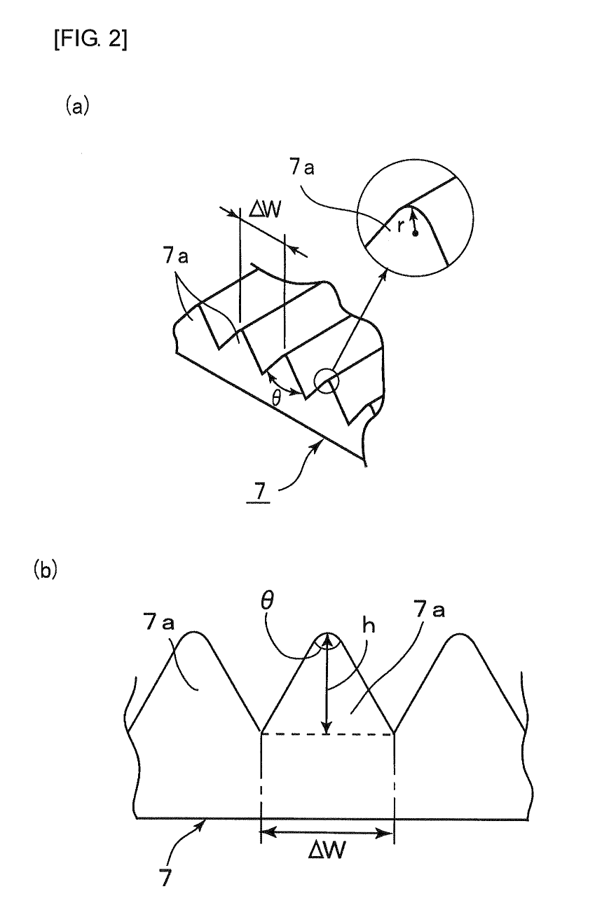

The prism sheet 7 has the structure in which a plurality of convex lens units 7a, 7a extending in one direction are provided in parallel on the upper surface of a sheet-like member. Hereinafter, the surface on which lens units 7a are provided, i.e., the upper surface, may be called a shaped surface. Specifically, as illustrated in a partially cut-out perspective view in FIG. 2(a), the lens units 7a, 7a have substantially isosceles triangle shapes in cross section and have ridge lines extending in a direction perpendicular to the cross section.

In the present embodiment, standardized T1/T2 is 0.02 or less, wherein T1 is a total transmittance of light incident from the shaped surface side of the prism sheet 7 on which the lens units are disposed, in a structure that the prism sheet is sandwiched between a pair of polarizers disposed in a cross Nicol arrangement to make a direction in which a ridge line of the lens units extends consistent with a transmission axis of either of the polarizers, and T2 is a total transmittance of light through a pair of polarizers disposed in a parallel Nicol arrangement, between which no prism sheet is sandwiched.

When T1/T2 exceeds 0.02, the luminance reduction caused by rotatory polarization or stray light is increased in an integrated state with the reflective polarizing functional film, and for example, sufficient luminance cannot be obtained when the prism sheet is mounted in the liquid crystal display. The normalized transmittance ratio T1/T2 can be presumably associated with an optical distortion in a film thickness direction, i.e., retardation in thickness direction, and in the present invention, since the normalized transmittance ratio T1/T2 is preferably 0.02 or less, more preferably 0.01 or less, it is possible to secure a large viewing angle and a high luminance.

In the present embodiment, the apex angle θ of the isosceles triangle illustrated in FIGS. 2(a) and 2(b) is preferably 70° to 110°. When the apex angle departs from the range, it is liable to be impossible to secure sufficient luminance.

The distance between the apexes of adjacent lens units 7a, 7a, namely, a groove pitch “ΔW” is preferably set in the range of 20 to 100 μm. The lens units with “ΔW” of less than 20 μm are actually difficult to produce; whereas when “ΔW” exceeds 100 μm, the lens units interfere with the pixels of a liquid crystal cell or a color filter, which may generate moire and lead to poor appearance.

In the present embodiment, the rate of transcription is set to 50 to 90% in order to enlarge a half-luminance angle width and increase a viewing angle. The rate of transcription used herein is a ratio of the actual height of the lens units 7a to the height of the lens units 7a in the case where a curvature radius of the apex is 0.

When the rate of transcription exceeds 90%, the front luminance becomes high, but the half-luminance angle width may become small and the viewing angle may become narrow. When the rate of transcription is less than 50%, the viewing angle increases, but the luminance may decrease. Therefore, when the rate of transcription is 50 to 90%, the front luminance is high, the half-luminance angle width is large, and a sufficient viewing angle can be realized; on the other hand, when it is 60 to 80%, it is possible to secure a high luminance and a large viewing angle characteristic.

Since the half-luminance angle width can be enlarged and the viewing angle can be increased, the curvature radius “r” of the apex of the lens units 7a is preferably 2 to 10 μm.

In order to enlarge a half-luminance angle width and increase a viewing angle, a surface roughness is applied to a pair of inclined surfaces of lens units, and preferably, a surface roughness “Ra” of not more than 0.1 to 5 μm in terms of an average surface roughness of JIS B0601 is applied thereto. In the case where the surface roughness “Ra” is 0.1 to 5 μm, it is possible to sufficiently enhance the front luminance. When the surface roughness “Ra” exceeds 5 μm, the front luminance may decrease. The surface roughness “Ra” is more preferably 0.3 to 4 μm, which range can further enhance the front luminance.

A front luminance reduction rate “C” calculated by {(A−B)/A}×100 is preferably 5% or less, wherein “A” is a front luminance in a case where a standard prism sheet 7 having a thickness of 150 μm, a lens-unit pitch of 50 μm, an apex angle of 90°, and a rate of transcription of 95% or more is disposed below a reflective polarizing functional film so that a prism surface faces the reflective polarizing functional film, and “B” is a front luminance in a case where the prism sheet 7 is disposed above the reflective polarizing functional film so that a non-prism surface faces the reflective polarizing functional film. The front luminance reduction rate thereby makes it possible to secure a high front luminance, and to achieve the same degree of front luminance in comparison with the configuration in which a prism sheet is disposed on the backlight side of the reflective polarizing functional film.

A half-luminance angle width of a front luminance reduction rate “Z” calculated by {(X−Y)/X}×100 is preferably 3% or less, wherein “X” is a half-luminance angle width of a front luminance in a case where a standard prism sheet 7 having a thickness of 150 μm, a lens-unit pitch of 50 μm, an apex angle of 90°, and a rate of transcription of 95% or more is disposed below a reflective polarizing functional film so that a prism surface faces the reflective polarizing functional film, and “Y” is a half-luminance angle width of a front luminance in a case where the prism sheet 7 is disposed above the reflective polarizing functional film so that a non-prism surface faces the reflective polarizing functional film. The half-luminance angle width reduction rate of 3% or less makes it possible to secure a large half-luminance angle width, and to achieve the same degree of front luminance in comparison with the configuration in which a prism sheet is disposed on the backlight side of the reflective polarizing functional film.

In the present invention, the prism sheet may comprise one kind of resin or a plurality of kinds of resins, but is desirably formed of a single layer.

The thickness of a raw fabric of the prism sheet is preferably 50 to 300 μm, more preferably 50 to 250 μm, and further preferably 100 to 250 μm. When the thickness is less than 50 μm, the prism sheet is more likely to curl to the prism surface that form the lens unit 7a. When the thickness exceeds 300 μm, the transfer rate to the resin by forming may fall, and luminance may be reduced.

A melt extrusion method and a casting method, for example, are employable as a method for producing the prism sheet 7. Other examples include: a method for forming by using an object on which a substantially prism shape and a reverse pattern are engraved on a press surface; and a method for molding by injection molding; and the like. Examples of a method for roughing a slanted surface of the prism shape include: a method for applying roughness to the press surface by the sandblasting method, and transferring it; and a method for applying roughness to the press surface by performing treatment, such as lithography, etching, and plating, thereon, and transferring it; and the like. In terms of the accuracy of the prism shape and the production of the press, the method for applying roughness to the surface of the press mold by surface treatment is preferable.

In the present invention, in the case where the prism sheet is made of an optical transparent resin and produced by the hot-melt extrusion method, a higher luminance can be achieved. The hot-melt extrusion method makes it possible to form a shaped surface easily with high precision, and to obtain sufficient display quality.

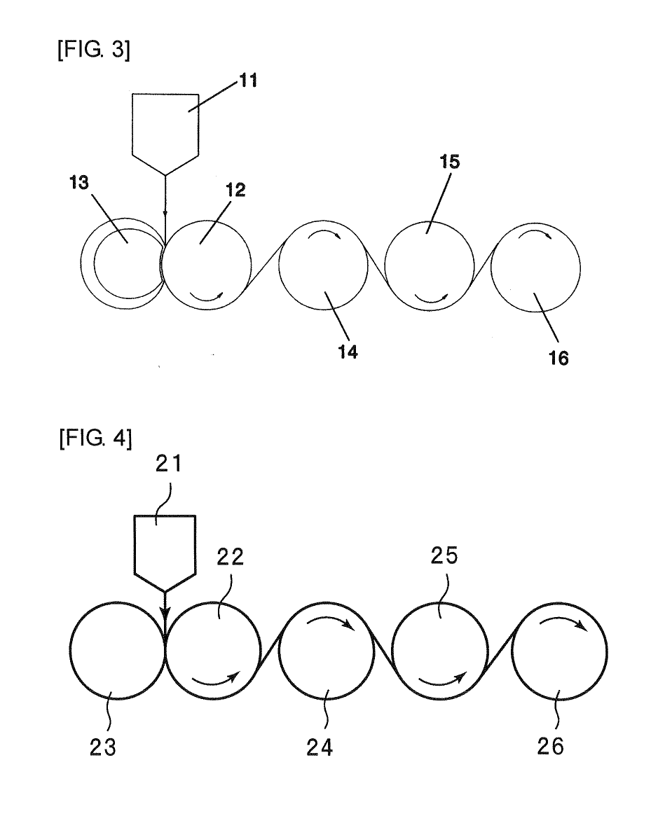

In the melt extrusion method, as illustrated in the configuration view in FIG. 3 and FIG. 4, after extruding a molten resin from T type dies 11 and 21 into a sheet shape, the molten resin is compressed between a forming roll 12 or 22 and a metal elastic deformation roll 13 or a metal roll 23. After the compression, the raw fabric of the prism sheet is cooled rapidly to set the raw fabric not more than the glass transition temperature “Tg” of resin. Next, the raw fabric of the prism sheet is allowed to pass through first and second annealing rolls 14, 24, 15, and 25 having a mirror surface and a temperature control function and to be cooled, whereby curling is prevented and the residual strain due to thermal stress is removed. Thereafter, the raw fabric of the prism sheet is wound into winders 16 and 26.

As a compression roll, the metal elastic deformation roll 13 is used in the device illustrated in FIG. 3, and the metal roll 23 is used in the production device illustrated in FIG. 4; and other configurations in FIG. 3 and FIG. 4 are the same.

If cooling after compression is insufficient and the temperature of the raw fabric of the prism sheet is a high temperature in the vicinity of the glass transition temperature “Tg”, molecules are oriented in the flow direction of resin upon passing through the first and second annealing rolls 14, 24, 15, and 25, and the optical distortion in a film plane will be large.

Therefore, the cooling temperature after compression is preferably lower than the glass transition temperature “Tg” by 10° C. or more, and more preferably by 20° C. or more. Thereby, it is possible to stabilize the behavior of resin and the molecular orientation in the flow direction can be controlled.

The prism sheet produced by the melt extrusion method as described above makes it possible to reduce the optical distortion in the film plane without a special production process.

The cooling after compression can be performed more efficiently by using the metal elastic deformation rolls 13 illustrated in FIG. 3 than by using the metal roll 23 in the device shown in FIG. 4. However, since a compression period is longer upon using the metal elastic deformation rolls 13 than upon using the metal roll 23, the cooling effect on resin is larger. When resin is quenched by the metal elastic deformation roll 13, the resin is cooled and solidified before the stress applied to resin by forming is relieved, and the residual strain resulting from the residual stress will remain in a lens unit part. This presumably results in a larger optical distortion in a thickness direction.

This proves that production of a prism sheet 7 with a device illustrated in FIG. 4 is more advantageous than production thereof with the device illustrated in FIG. 3 to reduce the optical distortion in the thickness direction.

The constituent material of the prism sheet according to the present invention is not particularly limited, and preferable examples thereof include resins excellent in transparency and moldability, such as a polycarbonate-based resin and a thermoplastic saturated norbornene-based resin.

One example of the polycarbonate resin is a resin obtainable by reacting dihydric phenol with a carbonate precursor by the interfacial polymerization method or the melt polymerization method.

The molecular weight of the polycarbonate resin is preferably 10,000 to 100,000 in terms of a viscosity-average molecular weight (M), and more preferably 15,000 to 35,000. Since the polycarbonate resin having the viscosity-average molecular weight has sufficient strength and good melt flowability upon molding, that is preferable.

Examples of the thermoplastic saturated norbornene-based resin include: (a) resins obtained by optionally modifying a ring-opened polymer or ring-opened copolymer of the norbornene-based monomer with addition of maleic acid or addition of cyclopentadiene, and thereafter hydrogenating the resultant product; (b) resins to which the norbornene-based monomer is addition-polymerized; (c) resins in which the norbornene-based monomer is addition-polymerized with an olefin-based monomer, such as ethylene and α-olefin; (d) resins in which the norbornene-based monomer is addition-polymerized with cyclic olefin-based monomers, such as cyclopentene, cyclooctane, and 5,6-dihydrodicyclopentadiene; modified products of these resins; and the like.

The thermoplastic saturated norbornene-based resin is marketed as “ZEONOR” and “ZEONEX” (trade names, produced by Zeon Corporation), “ARTON” (trade name, produced by JSR Corp.), and “APEL” (trade name, produced by Mitsui Chemicals, Inc.).

With respect to the number-average molecular weight of the thermoplastic saturated norbornene-based resin, the mechanical strength may be insufficient when it is small; and the film moldability is reduced when it is large. The number-average molecular weight is, therefore, measured by the gel permeation chromatograph using toluene or a suitable solvent, and is preferably 25000 to 100000, and more preferably 30000 to 80000. When the norbornene-based resin is used, the melt flowability upon molding is good, and that is preferable.

In the optical sheet according to the present invention, a reflective polarizing functional film is adhered to a surface opposite to a lens-unit shaped surface of the prism sheet. As long as achieving the function, the reflective polarizing functional film is not limited, and can be formed, for example, in the structure in which two kinds of transparent resins are alternately laminated over a plurality of layers, for example, hundreds of layers.

### Examples and Comparative Examples

As the resin material for prism sheets according to Examples 1 to 4 and Comparative Examples 1 to 3, a polycarbonate resin (Panlite L-1225L, produced by Teijin Chemicals Ltd.) was used.

The prism sheets according to Examples 1 to 4 were produced using the production device illustrated in FIG. 4.

A T type die 21 has a face length of 700 mm, a metal roll 23 has a diameter of 250 mm and has a mirror surface roll, a first annealing roll 24 and a second annealing roll 25 have a diameter of 250 mm and have a mirror surface roll. As the embossing roll 22, there was employed a embossing roll that has a diameter of 250 mm, has a plurality of V grooves of substantially rectangular isosceles triangles, respectively, in cross section on an outer peripheral surface, and was subjected to a surface treatment by the processing method described in Table 1.

The raw fabric of the prism sheet wound by a winder 26 has a size of 650 mm in width×150 μm in thickness.

The basic conditions were as follows. After extruding a molten resin from the T type die 21 into a sheet shape at an extrusion rate of 100 kg/hour, the resin was compressed with the embossing roll 22 and the metal roll 23 that was cooled to 10° C., whereby setting the temperature of the raw fabric of the prism sheet to not more than the glass transition temperature “Tg”. Then, the raw fabric of the prism sheet was allowed to pass through the first annealing roll 24 at 135° C. and immediately thereafter through the second annealing roll 25 at 95° C., and then wound by the winder 26. At this moment, a velocity of the roll of the winder 26 was 26 m/minutes and the velocity ratio between each of the rolls was set to 1.0. In addition, the compression force was changed to satisfy the above-mentioned specific conditions, and thereby the prism sheets according to Examples 1 to 4 were produced.

The prism sheets according to Comparative Examples 1 to 3 were produced using the production device illustrated in FIG. 3. The production conditions in this case were the same as those of Example 1, except that the above-mentioned specific conditions were not satisfied.

The geometric conditions (namely, a groove pitch ΔW, an apex angle θ, and a rate of transcription) in the prism sheets according to Examples 1 to 4 and Comparative Examples 1 to 3 are shown in Table 1.

The thus produced raw fabrics of the prism sheets according to Examples 1 to 4 and Comparative Examples 1 to 3 were cut into a predetermined length, and T1/T2, rates of transcription and slanted surface roughness were measured. As a reflective polarizing functional film, DBEFs (Dual Brightness Enhancement Film, thickness: 130 μm) produced by Minnesota Mining & Manufacturing Co. (3M) were laminated on the prism sheet thus obtained by cutting by using an adhesive so as to coincide the polarized light transmission axis of the reflective polarizing functional film with the ridge line direction of the prism sheet, and the front luminance and half-luminance angle width were evaluated in a state of the obtained laminated body. Table 1 shows the results.

Each of the items was measured in the procedures described in (1) to (5).

(1) T1/T2

Two polarizers were disposed so that transmission axes thereof intersected perpendicularly to each other (the transmission axis of the front polarizer was in a horizontal direction and the back polarizer was in a perpendicular direction). The prism sheet was sandwiched between the two polarizers to obtain a laminated structure so that a ridge line direction of the prism sheet was perpendicular to the transmission axis of the front polarizer. A total transmittance T1 of light beams incident from a shaped surface of the prism sheet in the laminated structure was measured with a haze meter (TC-H IIII DPK produced by Tokyo Denshoku Co., Ltd.). The measurement was also measured on the condition that T2 was a total transmittance of light through such a structure that a pair of polarizers (both of which have a transmittance axis in a perpendicular direction) were arranged in a parallel Nicol arrangement and that no prism sheet was sandwiched between the pair of polarizers. Table 1 shows the value expressed by % as T1/T2, i.e., the value calculated by (T1/T2)×100(%).

(2) Rate of Transcription

Carbon was applied to the section of the prism sheet cut with a microtome, and the section was observed with a scanning electron microscope (S-4300SE/N) produced by Hitachi, Ltd. to obtain a groove pitch “ΔW(μm)”, a prism height “h(μm)”, and an apex angle “θ(degree)” illustrated in FIG. 2(b). From these values, the rate of transcription was calculated by the following equation.

Rate of transcription=h/{(ΔW/2)tan(90−θ/2)}

(3) Slanted Surface Roughness

The prism shape was measured with a scanning laser microscope (1LM21W) produced by Lasertec Corporation to calculate the surface roughness (Ra) of the slanted surface with a data analysis software. Ra was calculated from the mean value of the surface roughness for two cycles in 100-μm pitch prism sheets, and for five cycles in 50-μm pitch prism sheets.

(4) Front Luminance

A prism sheet cut into a size of 300 mm in length×400 mm in width to be used as the measuring object and a laminated body of the reflective polarizing functional film were incorporated to a direct type backlight with which a commercial 20-inch liquid crystal television was equipped so that a ridge line direction of the lens was a transverse direction (horizontal direction) of the screen, and the front luminance was measured through the liquid crystal cell by means of a luminance meter, LS-100 produced by Konica Minolta Holdings, Inc.

(5) Half-Luminance Angle Width

The half-luminance angle width is a viewing angle range in which 50% luminance of the luminance in the normal direction to a display surface is obtained. With the configuration mentioned above, a luminance meter was attached to an genie arm, the luminance was measured at 5° intervals horizontally in the range of −70° to 70°, and the results were printed on a printer. The printed results were shown by a graph to calculate the angle range in which the luminance is half of the front luminance.

In order to investigate the influence of the optical distortion of the prism sheet, with respect to (4) a front luminance and (5) a half-luminance angle width, the luminance and half-luminance angle width in the normal direction in the case where DBEF produced by Minnesota Mining & Manufacturing Co. was disposed, as a reflective polarizing functional film, on the shaped surface of the prism sheet having a prism pitch of 50 μm, an apex angle of 90°, and a rate of transcription of 95% and having been produced by using the production device illustrated in FIG. 4, were set to their reference values. That is, the reduction rates of the luminance and half-luminance angle width which were actually measured as mentioned above from the luminance and half-luminance angle width as the reference values, were obtained. The following Table 1 shows the obtained rates. The thus obtained luminance reduction rate and half-luminance angle width reduction rate correspond to the luminance reduction rate “C” (%) calculated by {(A−B)/A)}×100 as mentioned above and the half-luminance angle width reduction rate “Z” (%) calculated by {(X−Y)/X}×100.

TABLE 1

| | | | | | | | | | | Half- |
|---|---|---|---|---|---|---|---|---|---|---|
| | | | | | | Roughness of | | Half- | | luminance |
| | Groove | Apex | | Rate of | Surface | Inclined | Front | luminance | Luminance | Angle Width |
| | Pitch | Angle | T1/T2 | Transcription | Treatment | Surface | Luminance | Angle Width | Reduction Rate | Reduction Rate |
| | μm | ° | % | % | Method | μm | cd/m2 | ° | % | % |
| Ex. 1 | 50 | 92 | 1.99 | 72.4 | Metal Plating | 0.4 | 393.6 | 107.5 | 3.6 | 1.4 |
| Ex. 2 | 50 | 92 | 0.74 | 81.4 | Metal Plating | 0.4 | 402.2 | 108.0 | 1.5 | 0.9 |
| Ex. 3 | 50 | 90 | 0.74 | 71.0 | Sand Blasting | 2.5 | 405.9 | 113.0 | 0.6 | −3.6 |
| Ex. 4 | 50 | 92 | 0.74 | 52.9 | Sand Blasting | 2.5 | 389.1 | 116.0 | 4.7 | −6.4 |
| Comp. | 50 | 90 | 2.48 | 75.7 | Sand Blasting | 2.5 | 380.5 | 108.0 | 6.8 | 0.9 |
| Ex. 1 | | | | | | | | | | |
| Comp. | 100 | 97 | 7.20 | 92.0 | Sand Blasting | 2.5 | 392.4 | 95.0 | 3.9 | 12.8 |
| Ex. 2 | | | | | | | | | | |
| Comp. | 50 | 92 | 4.71 | 87.4 | Metal Plating | 0.4 | 404.9 | 97.5 | 0.8 | 10.6 |
| Ex. 3 | | | | | | | | | | |

As shown in Table 1, in the prism sheets 7 according to Examples 1 to 4 in comparison with the prism sheets according to Comparative Examples 1 to 3, T1/T2 can be reduced, a high front luminance can be secured, and a large half-luminance angle width can be secured by setting the rate of transcription preferably to 50 to 90%.

That is, by setting T1/T2 to 2% or less, and preferably setting the rate of transcription to 50 to 90%, it is possible to keep the luminance reduction rate “C” not more than 5% and to keep the half-luminance angle width reduction rate “Z” not more than 3%. It can be seen that even in comparison with the configuration in which the conventional prism sheet was disposed on the lower side, the prism sheets 7 according to Examples 1 to 4 shows the same degree of display performance.

1. A prism sheet,
which comprises a plurality of lens units having substantially triangle shapes in cross section, and having ridge lines extending in a direction perpendicular to the cross section, said plurality of lens units being formed in parallel on at least one surface,
wherein T1 and T2 defined below satisfy the following Equation (1)
T1≦T2×0.02 Equation (1)
wherein T1 is a total transmittance of light incident from a side on which said plurality of lens units of the prism sheet are disposed in such a laminate structure that the prism sheet is sandwiched between a pair of polarizers disposed in a cross Nicol arrangement to make a direction in which a ridge line of the lens units extends consistent with a transmission axis of either of the polarizers, and
T2 is a total transmittance of light through a laminate structure, said laminate structure consisting of a pair of polarizers disposed in a parallel Nicol arrangement, and no prism sheet being sandwiched between the pair of polarizers.

2. The prism sheet according to claim 1,
wherein T1 and T2 satisfy the following Equation (2)
T1≦T2×0.01 Equation (2)

3. The prism sheet according to claim 1,
wherein a rate of transcription of said plurality of lens units is 50 to 90%.

4. The prism sheet according to claim 1,
wherein a rate of transcription of said plurality of lens units is 60 to 80%.

5. The prism sheet according to claim 1,
wherein the prism sheet comprises an optical transparent resin and is produced by a hot-melt extrusion method.

6. The prism sheet according to claim 1,
wherein an apex angle of the cross section of said lens units is 70° to 110°.

7. The prism sheet according to claim 1,
wherein a pitch, which is a distance between apex of adjacent lens units, is 20 to 100 μm.

8. The prism sheet according to claim 1,
wherein a surface roughness of an inclined surface of each of said lens units is 0.1 to 5 μm in terms of a surface roughness “Ra” of JIS B0601.

9. The prism sheet according to claim 1,
wherein a front luminance reduction rate “C” calculated by {(A−B)/A}×100 is 5% or less,
wherein “A” is a front luminance in a case where a standard prism sheet having a thickness of 150 μm, a lens-unit pitch of 50 μm, an apex angle of 90°, and a rate of transcription of 95% or more is disposed below a reflective polarizing functional film so that a prism surface faces the reflective polarizing functional film, and
“B” is a front luminance in a case where said prism sheet is disposed above the reflective polarizing functional film so that a non-prism surface faces the reflective polarizing functional film.

10. The prism sheet according to claim 1,
wherein a half-luminance angle width reduction rate “Z” calculated by {(X−Y)/X}×100 is 3% or less,
wherein “X” is a half-luminance angle width in a case where a standard prism sheet having a thickness of 150 μm, a lens-unit pitch of 50 μm, an apex angle of 90°, and a rate of transcription of 95% or more is disposed below a reflective polarizing functional film so that a prism surface faces the reflective polarizing functional film, and
“Y” is a half-luminance angle width of a front luminance in a case where said prism sheet is disposed above the reflective polarizing functional film so that a non-prism surface faces the reflective polarizing functional film.

11. An optical sheet, which comprises:
a prism sheet according to any one of claims 1 to 10; and
a reflective polarizing functional film adhered to a face of the prism sheet opposite to a shaped surface of the prism sheet on which said lens units are formed.
